(19) United States
(12) Patent Application Publication
(10) Pub. No.: US 2004/0056439 A1
(43) Pub. Date: Mar. 25, 2004

(54) Narrow-aisle restocking cart

(75) Inventors: Radmond Arceta, Manassas, VA (US); David M. Dobersztyn, Stephenson, VA (US); Rhonda K. Baker, Inwood, WV (US)

Correspondence Address: FOLEY AND LARDNER, SUITE 500, 3000 K STREET NW, WASHINGTON, DC, 20007, US

(73) Assignee: RUBBERMAID COMMERCIAL PRODUCTS LLC

(21) Appl. No.: 10/421,930

(22) Filed: Apr. 24, 2003

Related U.S. Application Data
(60) Provisional application No. 60/374,825, filed on Apr. 24, 2002.
(60) Provisional application No. 60/383,144, filed on May 28, 2002.
(60) Provisional application No. 60/411,893, filed on Sep. 20, 2002.
(60) Provisional application No. 60/413,784, filed on Sep. 27, 2002.
(60) Provisional application No. 60/433,575, filed on Dec. 16, 2002.

(51) Int. Cl. B62B 3/00

(52) U.S. Cl. 280/47.34

(57) ABSTRACT

A cart includes a base having a deck for holding items and having at least a portion configured to move such that the deck can be changed from an expanded-length position to a reduced-length position, and a frame connected to the deck and configured to be disposed at a first length when the deck is in the expanded-length position and a shorter, second length when the deck is in the reduced-length position. The cart also includes rolling members supporting the base. It further includes a first upright member connected to and extending upwardly from the base.

### BACKGROUND OF THE INVENTION

1. Field of the Invention

The present invention relates to carriers and, more particularly, to a reconfigurable carrier that is adapted to be used in narrow aisles, as well as to a cart having a placard.

2. Description of Related Art

In an environment where it is necessary to move commercial stock, such as grocery stores, warehouses, and appliance stores, carts are often used to move the stock from one location to another location. For example, in an appliance store, a wheeled cart may be used to move boxed televisions from the loading dock or storage room to the show area.

There are problems with conventional carts. For example, when users restock aisles, the cardboard boxes that are used to package the goods are left over. The boxes are usually collapsed and placed on the floor in the aisle until the user completes the task of stocking the aisles, at which point he or she then gathers the collapsed boxes. By leaving the boxes in the aisle, a hazard is created. Also, the task of restocking the aisles looks unsightly. Alternatively, the boxes are placed on a separate cart brought by the end user solely to collect the empty boxes. This is inefficient.

Also, after restocking an aisle, the user is left with refuse from the product that was stocked, such as plastic wrappings, small cardboard pieces, packing foam, box ties, wires, box staples, etc. He or she is also left with other items of refuse, such as tape and spent razor blades.

Another problem is that the user often desires to carry a number of stocking items, such as magic markers, wire cutters, scissors, utility razors, flash lights, barcode scanners, note pads, walkie-talkies, pagers, safety glasses, safety gloves, etc. It can be difficult to carry those items with conventional carts.

Another problem that arises with conventional carts is that the end users sometimes have difficulty pushing and pulling the carts, especially when the carts are fully loaded.

Another problem with conventional carts is that they are bulky and require a tremendous amount of floor storage space.

Other problems can result from the way in which the carts are used. To efficiently to transport product throughout the store, the product often will be separated according to aisle number or food type. For example, one cart may carry only dog food. A sheet of paper will be taped to metal uprights of the cart and marked with the number of the aisle in which dog food is stocked or simply marked “dog food.” The workers will then take the individually marked carts to the appropriate aisle and commence stocking shelves. Paper or a writing instrument, however, may not be readily available when loading the carts. Also, tape to hold the paper on the cart may not be readily available. Additionally, the text on the sheet of paper may be difficult to read after it is posted on the cart. The paper also may fall off the cart.

### SUMMARY OF THE INVENTION

An aspect of the present invention relates to a cart including a base having a deck for holding items and having at least a portion configured to move such that the deck can be changed from an expanded-length position to a reduced-length position. The base also includes a frame connected to the deck and configured to be disposed at a first length when the deck is in the expanded-length position and a shorter, second length when the deck is in the reduced-length position. Rolling members support the base. A first upright member is connected to and extends upwardly from the base.

Another aspect of the invention relates to a cart including a base for holding items, rolling members supporting the base, a first upright member connected to and extending upwardly from the base, and a holding member that is moveable relative to the first upright member and configured to hold refuse from the items. The holding member is connected to at least one of the base and the first upright member.

Yet another aspect of the present invention relates to a cart including a base for holding items, rolling members supporting the base, a first upright member connected to and extending upwardly from the base, and a placard attached to the first upright member and having a surface for displaying information. The surface is configured such that the information can be changed.

Yet another aspect of the invention relates to a method for moving stock. The method includes the steps of providing a mobile cart having an upright member and a placard disposed on the upright member, identifying an item to be stocked, placing the item on the mobile cart, indicating on the placard a desired stocking location for the item, moving the mobile cart to the desired stocking location, and removing the item from the mobile cart and placing the item in the desired stocking location.

Yet another aspect of the invention relates to a holding member for mounting on an upright member extending from a base of a cart. The holding member includes a first frame configured to extend upwardly when the holding member is mounted on the upright member to provide an area for holding items between the first frame and the upright member. The holding member also includes a mounting mechanism for mounting the first frame to the upright member. The mounting mechanism includes at least two engaging portions configured to engage corresponding portions of the upright member. At least one of the engaging portions is adjustably connected to the first frame to permit the holding member to be mounted to different size upright members.

### BRIEF DESCRIPTION OF THE DRAWINGS

The accompanying drawings, which are incorporated in and constitute a part of this specification, illustrate a preferred embodiment of the invention and together with the description, serve to explain principles of the invention.

FIG. 1 is a perspective view of a first embodiment of a narrow-aisle restocking cart according to the present invention.

FIG. 2 is a side view of the narrow-aisle restocking cart of FIG. 1.

FIG. 3 is an end view of the narrow-aisle restocking cart of FIG. 1.

FIG. 4 is an end view of the narrow-aisle restocking cart of FIG. 1.

FIG. 5 is a top view of the narrow-aisle restocking cart of FIG. 1.

FIG. 6 is a bottom view of the narrow-aisle restocking cart of FIG. 1.

FIG. 7 is a top perspective view of the narrow-aisle restocking cart of FIG. 1, with the cart shortened in length.

FIG. 8 is a bottom perspective view of the narrow-aisle restocking cart of FIG. 1, with the cart shortened in length.

FIG. 9 is a bottom perspective view of the narrow-aisle restocking cart of FIG. 1.

FIG. 10 is a bottom, perspective, exploded view of the narrow-aisle restocking cart of FIG. 1.

FIG. 11 is a partial, bottom, perspective, exploded view of the narrow-aisle restocking cart of FIG. 1.

FIG. 12 is a perspective view of the narrow-aisle restocking cart of FIG. 1, with a holding member extended.

FIG. 13 is a perspective view of an embodiment of a workstation of the narrow-aisle restocking cart of FIG. 1.

FIG. 14 is a perspective view of an embodiment of a placard of the narrow-aisle restocking cart of FIG. 1.

FIG. 15 is a front view of the placard of FIG. 14.

FIG. 16 is a bottom view of the placard of FIG. 14.

FIG. 17 is a top view of the placard of FIG. 14.

FIG. 18 is a perspective view of the placard of FIG. 14 with graphics.

FIG. 19 is a perspective view of the placard of FIG. 14 with graphics.

FIG. 20 is a perspective view of a portion of the narrow-aisle restocking cart of FIG. 1 having a refuse bin.

FIG. 21 is a side, partial cross-sectional view of a portion of the narrow-aisle restocking cart of FIG. 1 having a sign.

FIG. 22 is a perspective view of a second embodiment of a narrow-aisle restocking cart according to the present invention.

FIG. 23 is a perspective view of a portion of a third embodiment of a narrow-aisle restocking cart according to the present invention having a pivoting holding member.

FIG. 24 is a side view of a portion of a fourth embodiment of a narrow-aisle restocking cart according to the present invention having a holding member that can be fixed in different positions.

FIG. 25 is a side view of a portion of the narrow-aisle restocking cart of FIG. 24, with the holding member in a lowered position.

FIG. 26 is a perspective view of a fifth embodiment of a narrow-aisle restocking cart according to the present invention having telescoping and folding upright members.

FIG. 27 is a perspective view of the narrow-aisle restocking cart of FIG. 26.

FIG. 28 is a perspective view of the narrow-aisle restocking cart of FIG. 26.

FIG. 29 is a partial cross sectional view of a portion of the narrow-aisle restocking cart of FIG. 26.

FIG. 30 is a perspective view of a sixth embodiment of a narrow-aisle restocking cart according to the present invention having holding straps.

FIG. 31 is a perspective view of an embodiment of shelves that can be used with a narrow-aisle restocking cart according to the present invention.

FIG. 32 is a perspective view of an embodiment of a rod that can be used with a narrow-aisle restocking cart according to the present invention.

FIG. 33 is a side view of a sixth embodiment of the invention, showing a holding member.

FIG. 34 is a rear view of the holding member of FIG. 33.

FIG. 35 is a side view of the holding member of FIG. 33.

FIG. 36 is a front view of the holding member of FIG. 33.

FIG. 37 is a bottom view of the holding member of FIG. 33.

FIG. 38 is a top view of the holding member of FIG. 33.

FIG. 39 is a front perspective view of the holding member of FIG. 33 mounted on an upright member of a cart.

FIG. 40 is a partial front perspective view of the holding member of FIG. 33 mounted on the upright member of the cart.

FIG. 41 is a partial rear perspective view of the holding member of FIG. 33 mounted on the upright member of the cart.

FIG. 42 is a front perspective view of the holding member of FIG. 33 showing adjustable engaging portions.

FIG. 43 is a front perspective view of the holding member of FIG. 33 showing adjustable engaging portions.

### DETAILED DESCRIPTION OF PREFERRED EMBODIMENTS

Reference will now be made in detail to presently preferred embodiments of the invention, examples of which are illustrated in the accompanying drawings. An effort has been made to use the same reference numbers throughout the drawings to refer to the same or like parts.

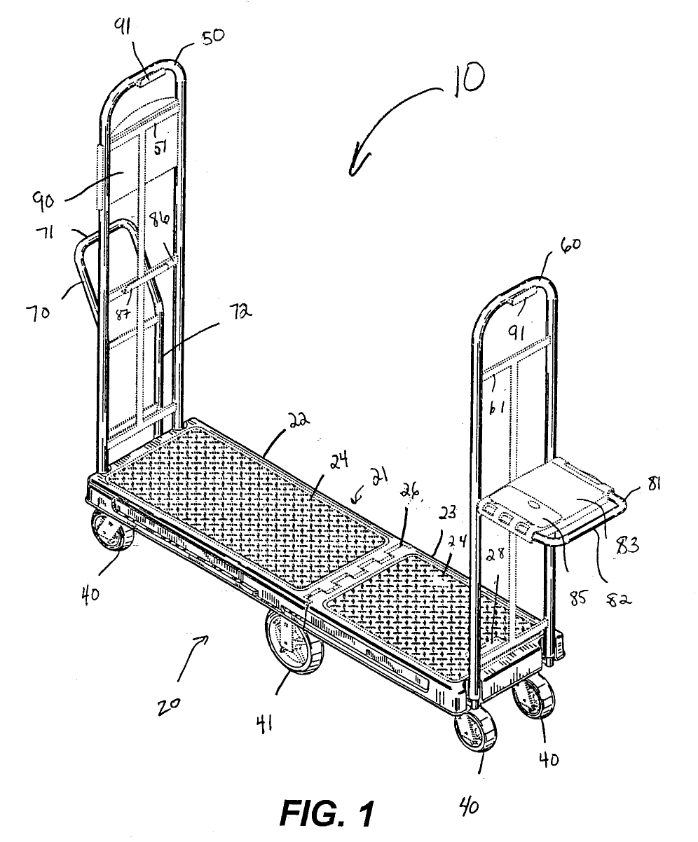

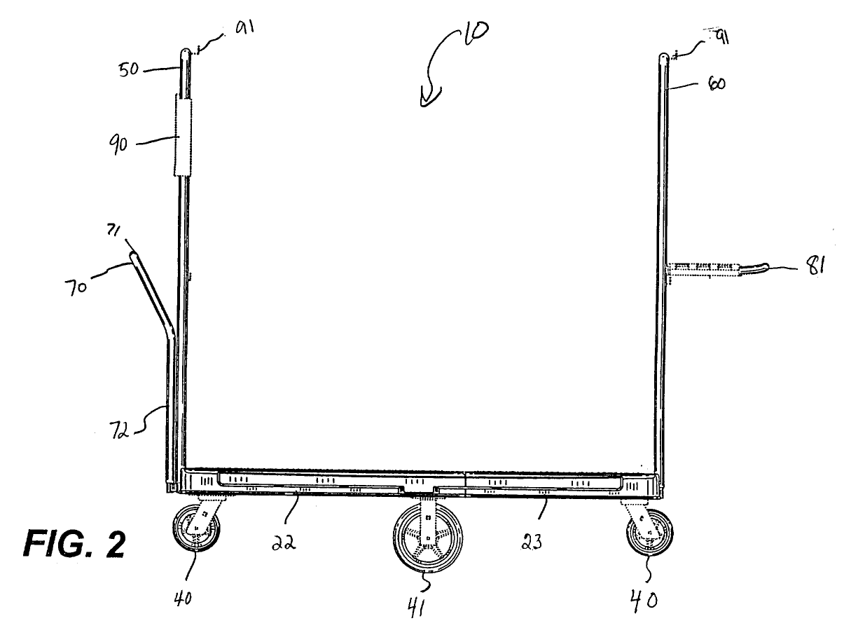

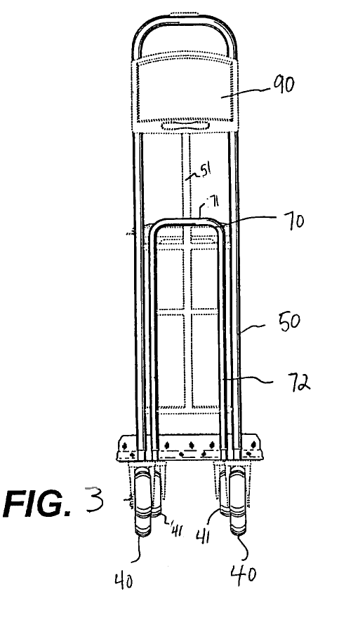

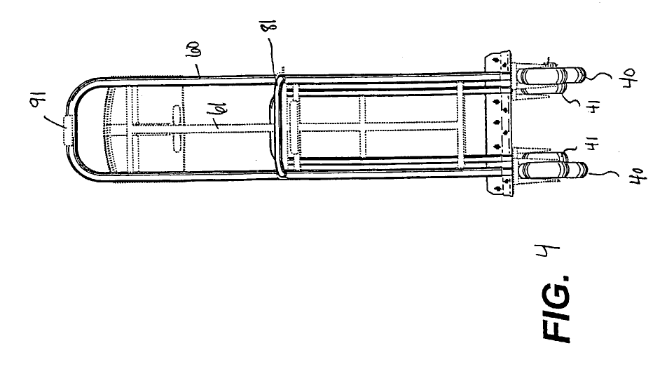

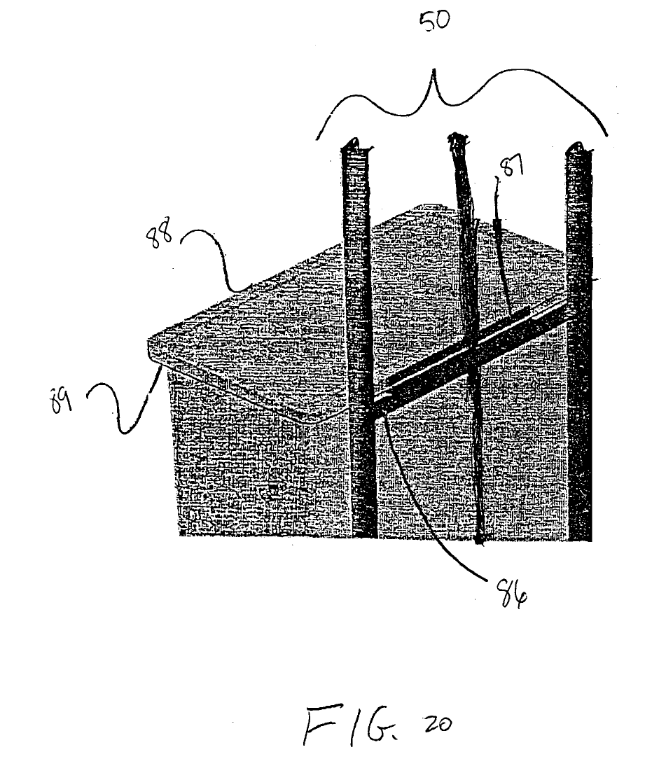

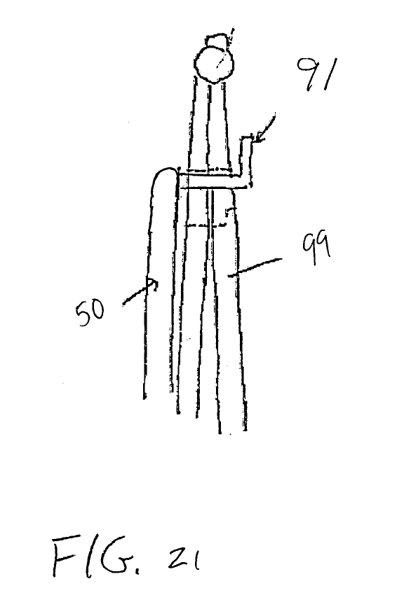

FIGS. 1 to 21 show a first preferred embodiment of a cart 10 according to the present invention. The cart 10 is preferably a narrow-aisle restocking cart. In this embodiment, the cart 10 has a base 20, rolling members 40, 41 supporting the base, and upright members 50 and 60.

The base 20 preferably includes a deck 21 for holding items. The deck 21 preferably can be changed from an expanded-length position to a reduced-length position. This allows a user to reduce the overall footprint of the cart 10, which is especially useful in tight areas and during storage of the cart 10.

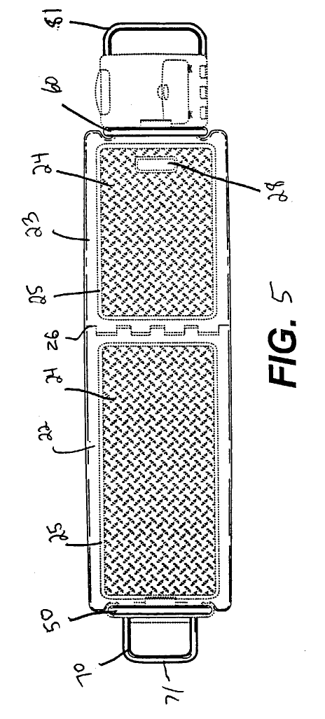

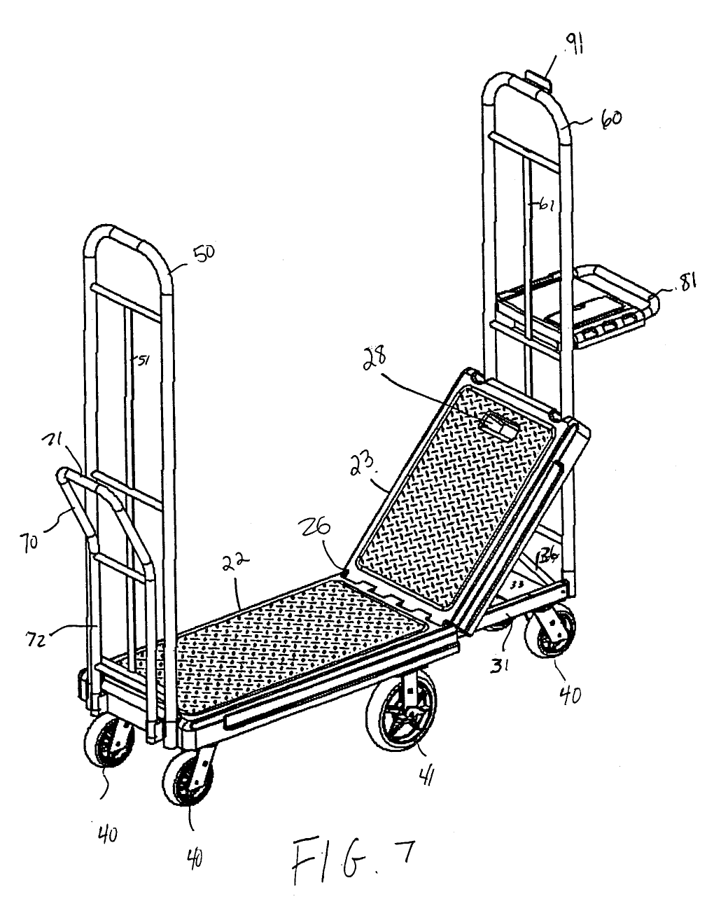

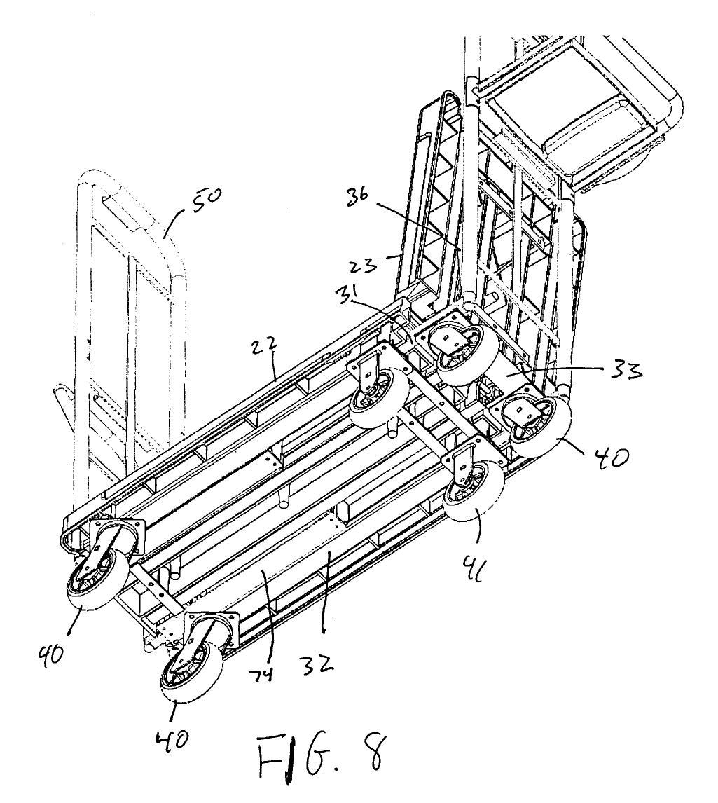

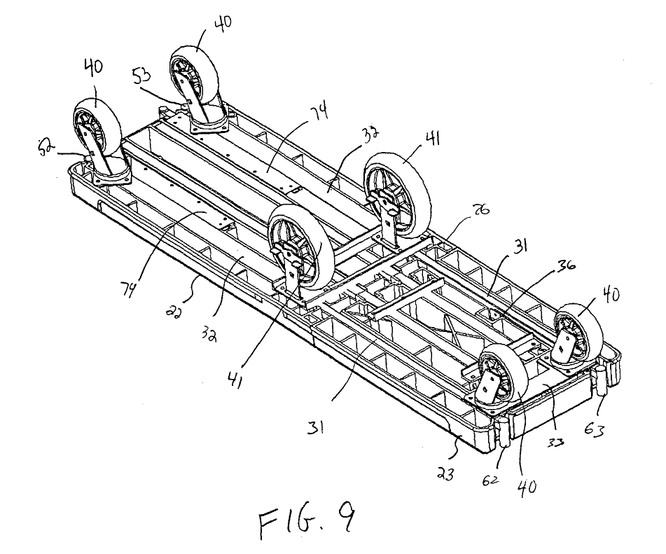

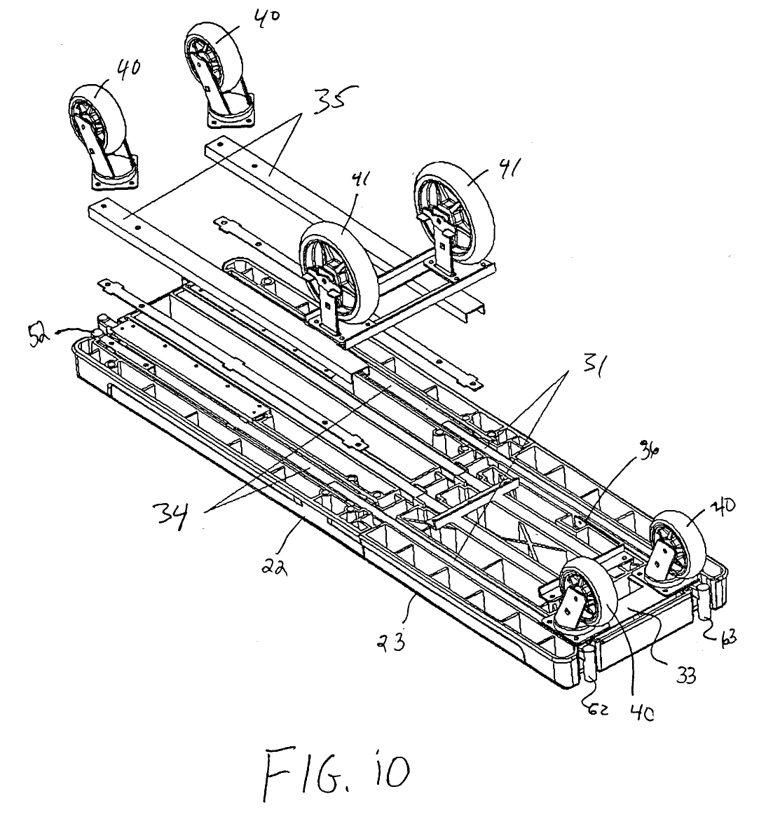

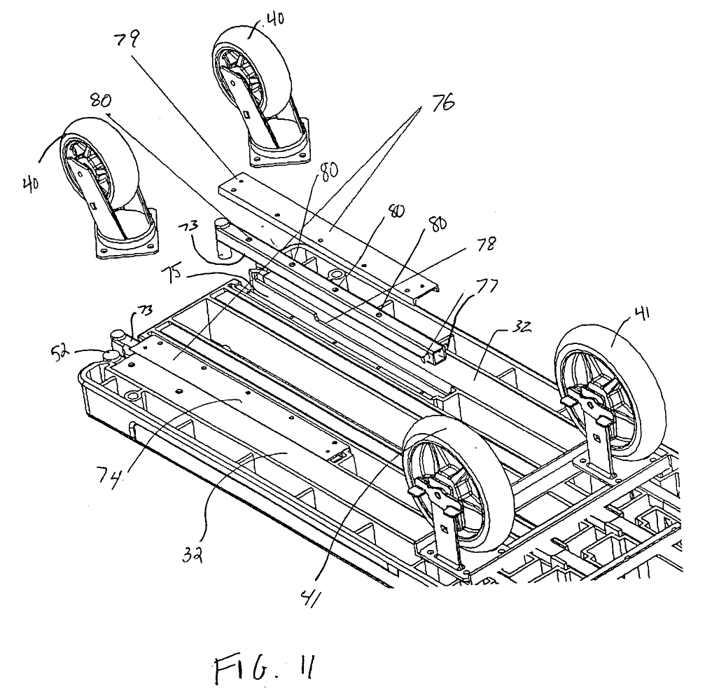

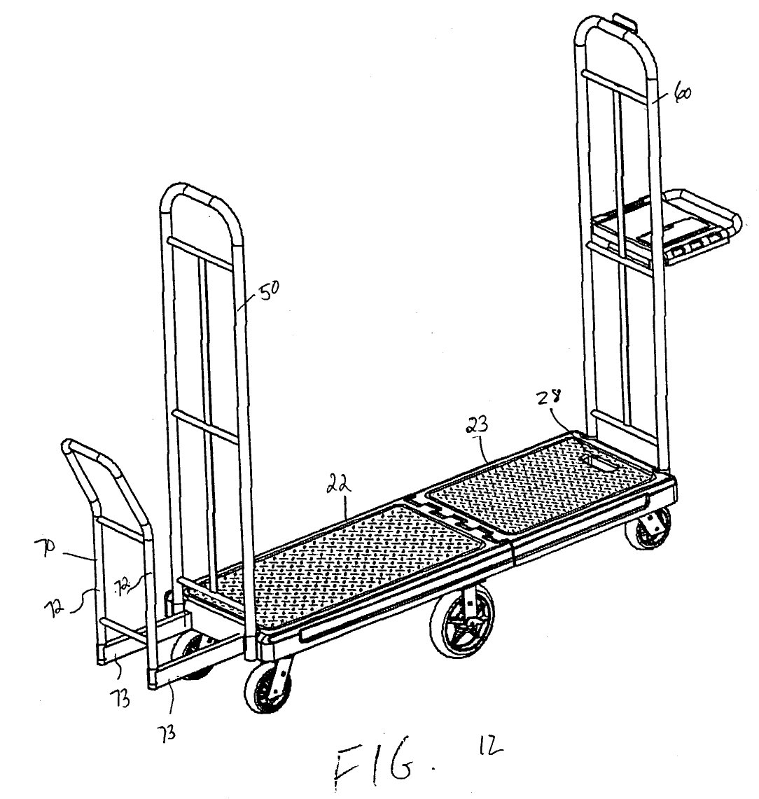

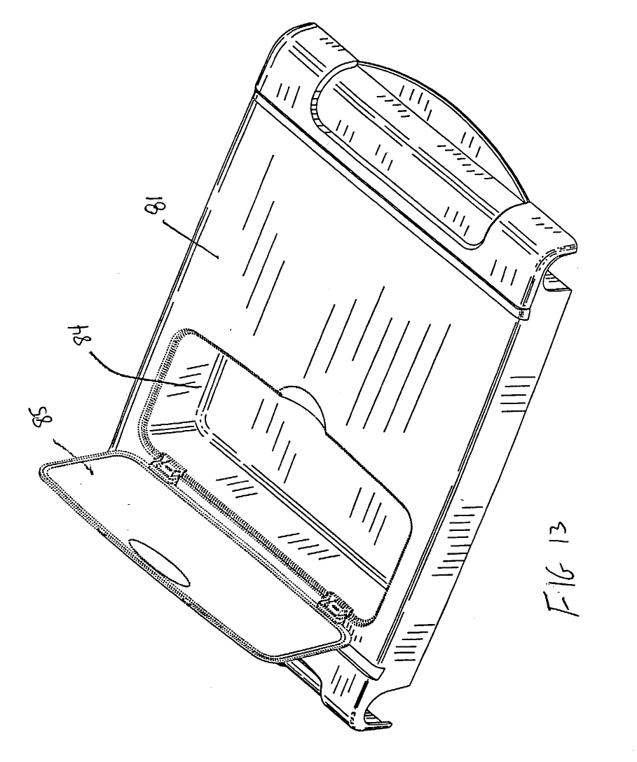

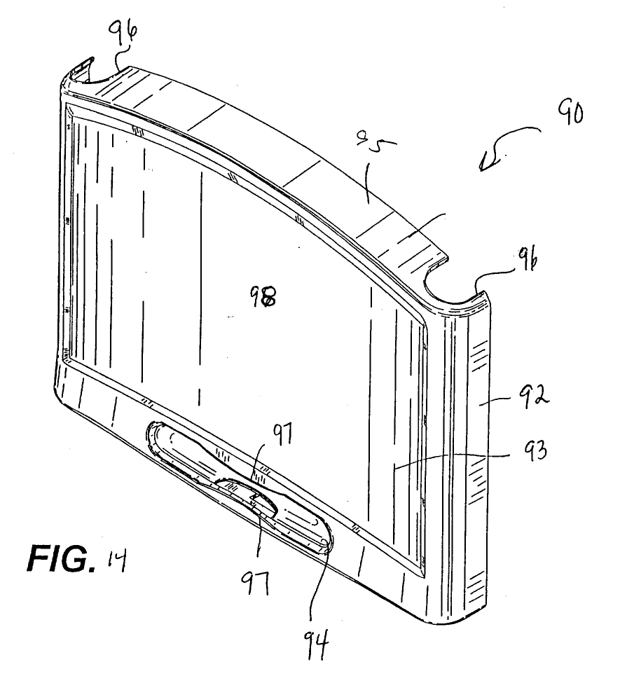

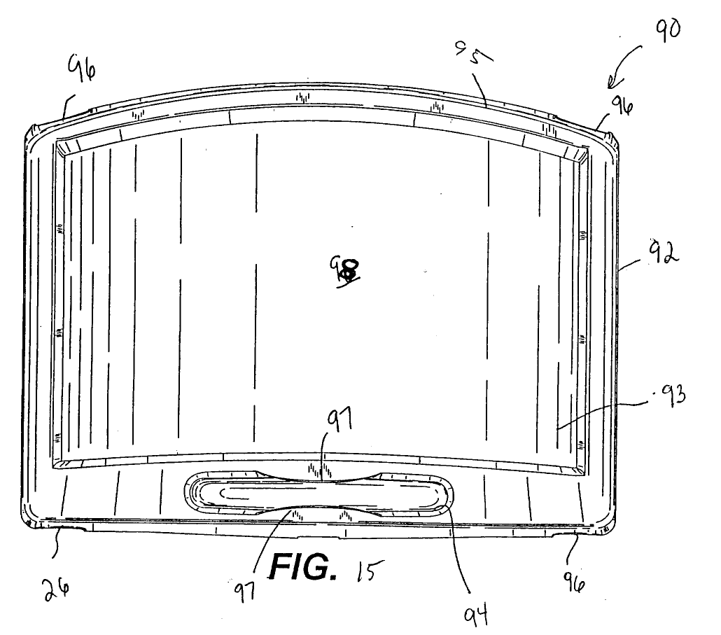

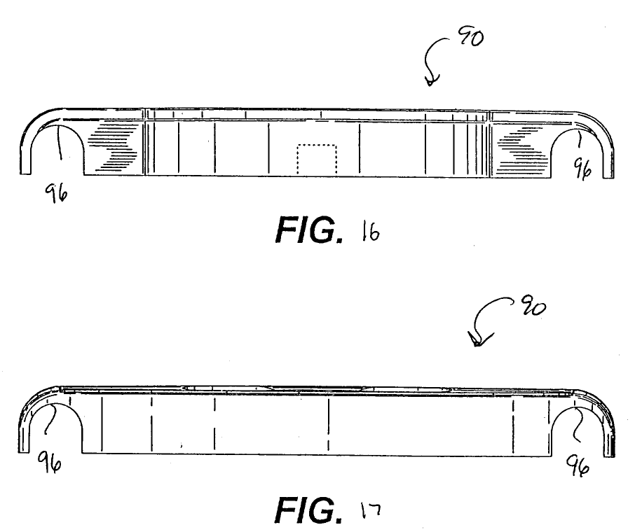

The deck 21 can include first and second portions 22 and 23. The first and second portions 22, 23 preferably provide a flat support surface. They can be made from plastic by a structural foam process. Each of the first and second portions 22, 23 preferably has molded in diamond plating 24 to improve frictional engagement. Each of the first and second portions 22, 23 preferably has a moat 25 (see FIG. 5) near its periphery for collecting liquid. The first and second portions 22, 23 preferably also are connected to one another by a conventional hinge structure 26 such that the second portion 23 can be pivoted relative to the first portion 22, as shown by comparing FIGS. 1 and 7.

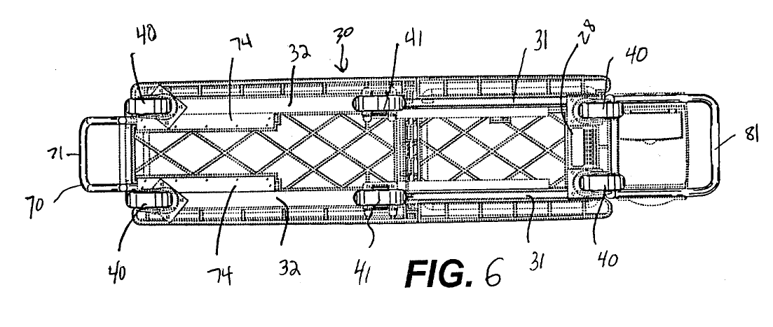

The base 20 preferably also includes a frame 30 (see FIG. 6) connected to the deck 21 and configured to be disposed at a first length when the deck 21 is in the expanded-length position (FIG. 1) and a shorter, second length when the deck 21 is in the reduced-length position (FIG. 7). The frame 30 can include fingers 31 and receiving members 32. The fingers 31 can be metal bars. Preferably the outer periphery of each finger 31 is smaller than the inner periphery of the corresponding receiving member 32. Although two fingers 31 are shown, more or less fingers could be used. The fingers 31 are held together at their ends by attachment portion 33 which can be made of a steel plate connected to the fingers 31 by conventional means. The receiving members 32 are preferably formed by channels 34 molded as part of the first portion 22 and configure to accept fingers 31 and by C-channels 35 that cover the channels 34 to keep the fingers 31 in the channels 34. The C-channels 35 can be bolted to the first portion 22.

Pivoting of the second portion 23 relative to the first portion 22 can be caused by grasping the second portion 23 at a gripping hole 28 and pulling the second portion 23 slightly upwards, then pushing the upright member 60 towards the upright member 50. The length of the cart 10 can then be reduced by sliding the fingers 31 into receiving members 32.

When the fingers 31 are slid into the receiving members 32, an arm or connecting bar 36 (FIGS. 8 and 9) causes movement of the second portion 23. In particular, the connecting bar 36 is pivotally connected to one of the fingers 31 and to the bottom of the second portion 23. As the fingers 31 move into the receiving members 32, the connecting bar 36 forces the second portion 23 upward and causes it to rotate about hinge structure 26. The connecting bar 36 also prevents the fingers 31 from pulling completely out of receiving members 32 when the second portion 23 is fully lowered.

The cart 10 preferably also includes rolling members 40 and 41 supporting the base 20 and which allow it to roll on the ground. In a preferred embodiment, the rolling members 40 and 41 are casters. The rolling members 40 and 41 can be connected to the base 20 by conventional means. For example, as shown in FIG. 6, end rolling members 40 are connected to the first portion 22, center rolling members 41 are connected to the first portion 22, and end rolling members 40 are connected to the attachment portion 33. The rolling members 40 and 41 are not all uniform in size. As can be seen in FIG. 1, the center rolling members 41 have a total height that is larger than the end rolling members 40, allowing the cart 10 to see-saw; the middle rolling members 41 being the fulcrum. This provides for ease of maneuverability.

The upright members 50 and 60 are connected to and extend upwardly from the base 20. They preferably are connected to first and second end portions of the base 20. They preferably are made from bent tubular powder-coated steel components that are welded together, although other suitable materials can be used. The upright members 50 and 60 are preferably bent to form an inverted “U” shape. The upright members 50 and 60 in the preferred embodiment can have a circular cross section, and can be hollow. Additionally, the upright members 50, 60 have respective inner frames 51 and 61, which are also made from metal and joined with the upright members by conventional techniques, such as welding. The ends of upright member 60 can be fit over and attached to pins 62, 63 (see FIG. 9), which are fixed to the ends of fingers 31. The ends of upright member 50 can be fit over and attached to pins 52, 53 (see FIG. 9), which are mounted to the first portion 22. In the preferred embodiment, the upright members 50, 60 are maintained on the pins by gravity and friction.

A holding member 70 is moveable relative to the first upright member 50 and configured to hold refuse from the items. The holding 70 member can be connected to the base 20 and/or the first upright member 50. In this preferred embodiment, the holding member 70 is attached to the deck 21 of the base 20. The holding member 70 preferably is made from steel and is formed in part to be an inverted “U”. The holding member 70 can be used as a handle for pulling or pushing the cart. The holding member 70 also can be used to collect, for example, cardboard and other packaging byproducts efficiently. The holding member 70 can hold items and keep them from falling off the cart while accommodating various cardboard quantities. Of course, this feature is not limited to storing cardboard, and can be used to hold other items as well, such as a television set.

The holding member 70 telescopes from underneath the deck 21 and can be moved toward and away from the upright member 50. Compare FIGS. 1 and 12. The holding member 70 preferably comprises a handle portion 71, vertical portions 72, and horizontal portions 73. The holding member 70 can be configured such that the handle portion 71 is at an appropriate height for gripping by a typical human adult.

The horizontal portions 73 interface with the deck 21 and allow the holding member 70 to telescope. As shown in FIG. 11, receiving members 74 are provided in the deck 21 and accept the horizontal portions 73. The receiving members 74 include channels 75 formed by molding as part of the first portion 22. C-channels 76 are connected to the first portion 22 to cover the channels 75 and keep the horizontal portions 73 in the channels 75 and to form the receiving member 74. The horizontal portions 73 can include metal pins 77 that slide in slots or rails 78 molded into the channels 75 of the receiving members 74. The travel of the metal pins 77 in the rails 78 limits the travel of the horizontal portions 73.

The horizontal portions 73 can be locked at various telescoping lengths. A socket head cap screw (not shown) is disposed in hole 79 in the C-channel 76, with the head of the screw protruding toward the horizontal portion 73. The head of the screw can engage holes 80 in the horizontal portion 73 to fix the horizontal portion in position. Gravity holds the head of the screw in a respective hole 80. Pulling up on holding member 70 allows the screw head to disengage from the holes 80 so the horizontal portion 73 can be telescoped. This arrangement can be provided for both of the horizontal portions.

A frame 81 can be provided on the upright member 60. The frame 81 can include a handle portion 82. The frame 81 can hold a workstation 83 with a recessed area 84 (FIG. 13) to store items such as markers, tape, and box cutters. A cover 85 can be pivotally mounted over the recessed area 84. The entire frame 81 can be made of, for example, metal. The workstation 83 can be made of, for example, molded plastic. Of course other materials can be used.

In the preferred embodiment, the frame 51 has a cross member 86. An “L” shaped hanger 87, preferably made of steel, is welded to the cross member 86. This permits a refuse bin 88 with an inverted “J” shaped lip 89 to be hung from erect portion of the hanger 87. A similar hanger can be provided on the frame 61 of upright member 60.

Hooks 91 can also be provided on the upright members 50, 60, respectively. The hooks 91 can be used to hang, for example, a sign 99. In the preferred embodiment, the hook, preferably made of steel, is an “L” shaped element welded to the upright member 60, much in the same way as the hanger 87. The sign 99 is placed around and rested on the hook 91. The erect portion of the hook 91 prevents the sign 99 from slipping off the hook.

A placard 90 can also be positioned on the upright members 50, 60. The placard 90 is preferably made of plastic and provides a surface for displaying information. FIGS. 14 to 19 show a preferred embodiment of a placard 90 according to the present invention. In this embodiment, the placard 90 includes a support portion 92, a display portion 93, and a writing instrument holder 94. Preferably the placard 90 is formed as an integral plastic member. It could be formed of polyethylene using a high-pressure injection molding process. Other processes, such as structural web and blow molding processes, and other materials, such as polypropylene, could be used to form the placard 90.

The support portion 92 holds the placard 90 in position. In a preferred embodiment, the placard 90 is designed to be mounted on a cart 10 (FIG. 1). The support portion 92 preferably includes a frame 95 that may include conventional ribs (not shown) for structural rigidity. The support portion 92 preferably also includes guides 96 that position the placard 90 relative to the metal upright member 50 of the cart 10. Screws (not shown) can be used to fix the placard 90 to the upright member 50.

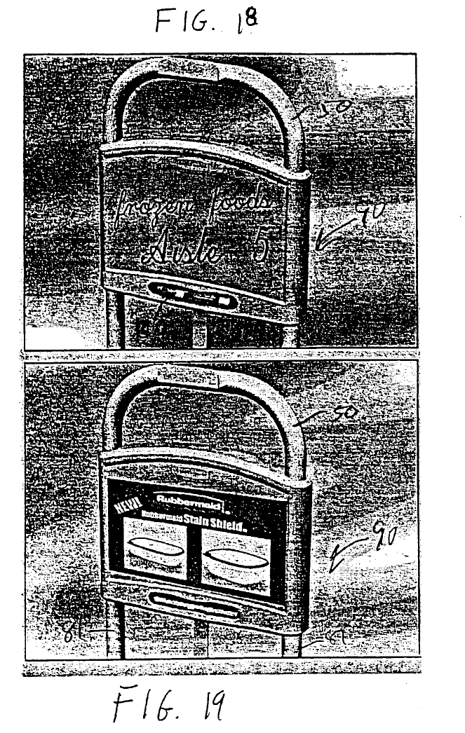

The display portion 93 permits information to be displayed. Preferably at least some of the display portion 93 is a generally flat surface 98 made of a conventional material that allows a user to write on the surface 98 with a dry erase marker. The user can thus write, for example, the aisle number or product type onto the surface 98. If an appropriate material is selected for the display portion 93, the writing can be easily wiped off at a later time. In addition, at least some of the display portion 93 can also be used to display other types of information, such as color graphics or advertising or color logos for branding (see FIGS. 18 and 19).

The writing instrument holder 94 holds a writing instrument 100 (see FIG. 18) in place. Preferably the writing instrument holder 94 is a molded area having clip portions 97 into which a writing instrument, such as a dry erase marker, can be snap fit.

FIG. 22 shows a second preferred embodiment of a cart 110 according to the present invention. This second embodiment is similar in many respects to the previously described embodiment. In this second embodiment, however, the base 120 includes a deck 121 that preferably is formed as an integral member. The deck 121 is preferably made from molded plastic. The deck 121 can have molded in diamond plating 24 to enhance frictional engagement. A moat 25 can be provided to capture liquid. In this embodiment, the hook 87 is preferably mounted on the opposite side (relative to the first embodiment) of cross member 86. Also, the hook 91 is preferably mounted on the opposite side of upright member 50.

FIG. 23 shows a portion of a third preferred embodiment of a cart 210 according to the present invention. This third embodiment is similar in almost all respects to the previously described first embodiment, except this third embodiment has a different holding member 170.

In this embodiment, the holding member 170 is attached to the upright member 50. The holding member 170 can be used as a handle for pulling or pushing the cart. The holding member 170 pivots along hinges 173 located near the base of the upright member 50, as can be seen in FIG. 23. The holding member 170 preferably is made from steel and is formed to be an inverted “U”, with the horizontal portion 171 of the “U” having the capability of serving as a handle. The portion 171 is bent forward slightly. The holding member 170 can be spring loaded by conventional means such that the top of the holding member 170 is biased towards upright member 50.

A member 180 is provided to hold, for example, cardboard or other packaging byproducts. The member 180 can be spring loaded by conventional means so that its top is biased towards upright member 50. Member 180 preferably is independently moveable relative to the holding member 170. The member 180 can hold items and keep them from falling off the cart while it is being pulled. Of course, this feature is not limited to storing cardboard, and can be used to hold other items as well.

FIGS. 24 to 25 show a portion of a fourth preferred embodiment of a cart 310 according to the present invention. This fourth embodiment is similar in almost all respects to the previously described first embodiment, except this fourth embodiment has a different holding member 270.

The holding member 270 is attached to the upright member 50. This holding member 270 essentially pivots relative to the upright member 50 with the aid of a locking device 274. The locking device 274 allows to holding member 270 to pivot to and lock at a variety of angles, depending on the user's needs. For example, the holding member 270 can be locked at 90 degrees (upright), as shown in FIG. 24, in the event that the user wants to use it as a push handle or a pull handle. It can be locked at 0 degrees (parallel with the deck 21 of the cart), as shown in FIG. 25 to provide additional storage area.

The locking device 274 comprises plates 276 welded to both of the bottom portions of holding member 270. The plates 276 each have a cutout 275, which includes fingers 277. The fingers 277 are located at various angles, thus allowing the user to vary the angle of the holding member 270. A steel bar 278 is welded across the bottom of upright member 50. To change the angle of holding member 270, the user lifts holding member 270 up so that the respective finger 277 is no longer engaged with the bar 278. The user then moves the holding member 270 so that the bar 278 engages another finger 277, thus setting the new angle of the holding member 270.

The holding member 270 could be spring loaded. The holding member 70 also could use both a spring and a locking device.

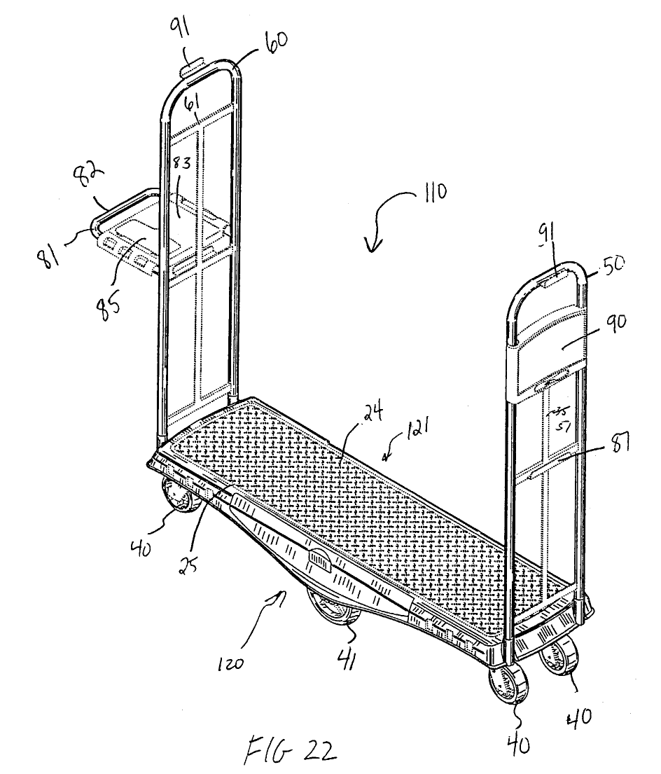

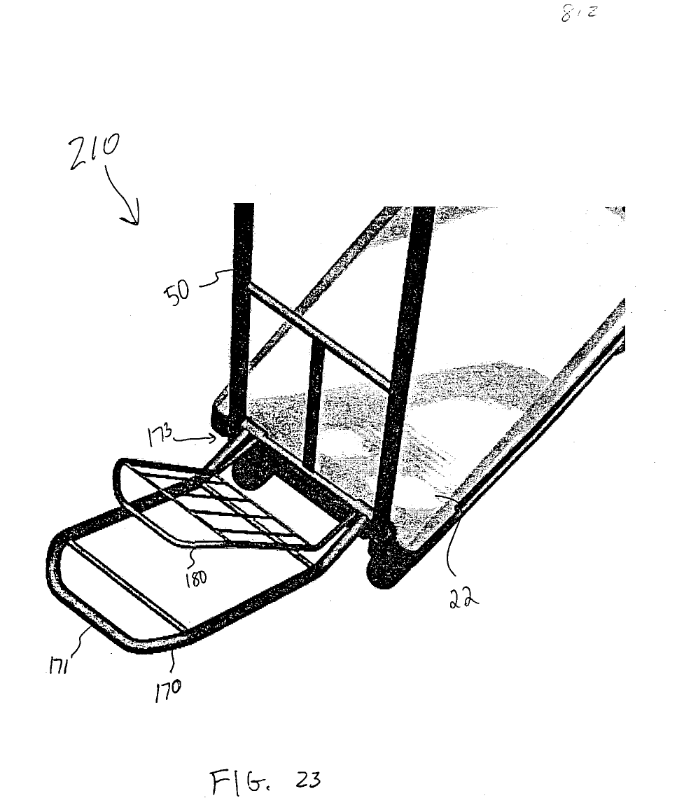

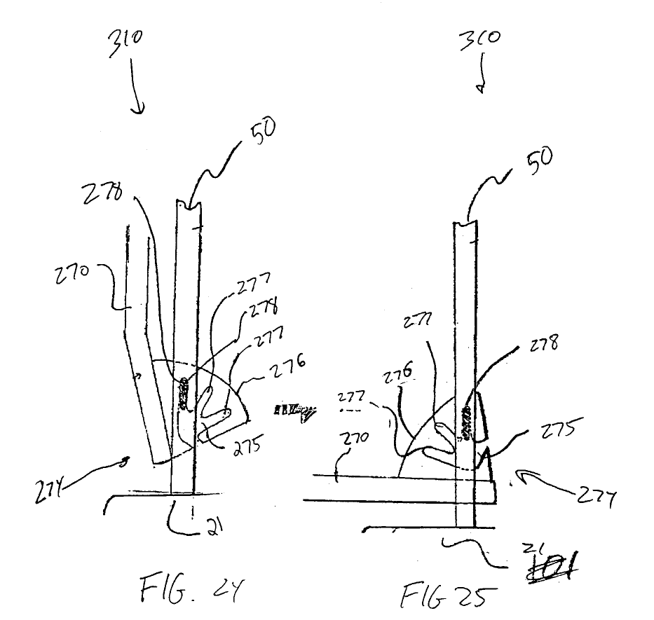

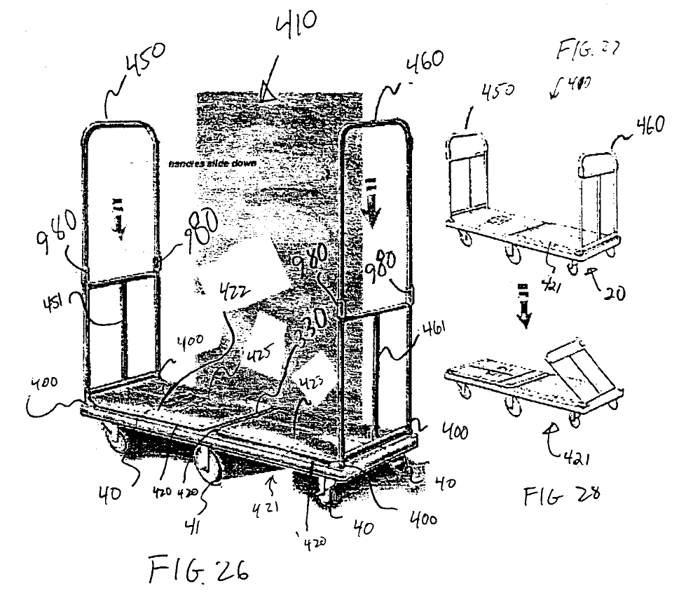

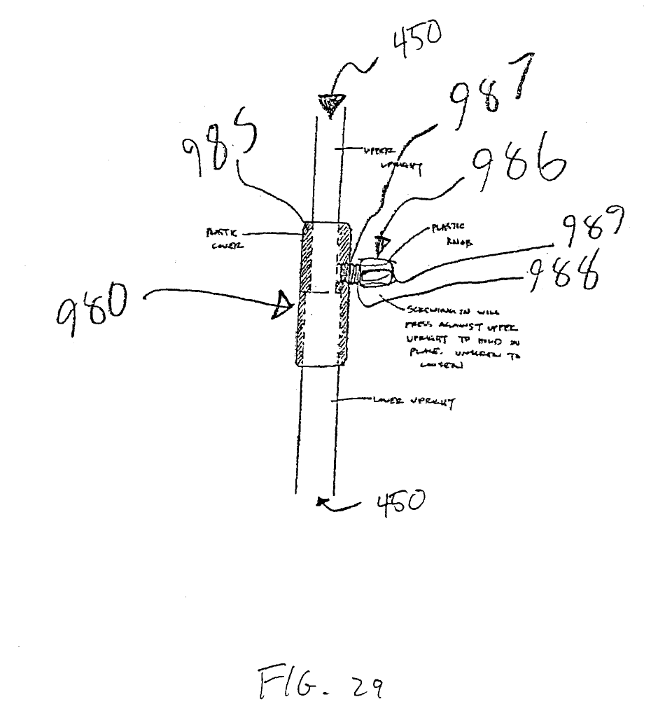

FIGS. 26 to 29 show a fifth preferred embodiment of a cart 410 according to the present invention. This fifth embodiment is similar in many respects to the previously described first embodiment. In this fifth embodiment, the upright members 450 and 460 telescope and fold. The upright members 450 and 460 each include an upper portion that telescopes into a lower portion in order to change the overall height of the cart 410. FIG. 26 shows the upright members 450 and 460 locked into place after they are telescoped to the desired height. Two locks 980 are positioned on each of the upright members 450 and 460. Each lock 980 comprises a plastic tubular cover 985, which has internal dimensions sufficient to interface with both the male portions of the upright members and the female portions of the upright members. The cover 985 has a threaded hole 987 in one side of the cover. Hole 987 is positioned to be in the vicinity of the female portion of the upright members. A knob 986 with a threaded portion 988 and a grip portion 989 is positioned in the threaded hole 987. Once the upright is telescoped to the desired height, the knob is screwed into the cover, allowing the end of the threaded portion 988 to contact the female portion of the upright, locking the upright into place.

Also, conventional hinges 400 can be provided at the bottom of the vertical upright members 450 and 460 to allow the upright members to fold. They can be locked in the upright positions by conventional means. Recessed areas 420 can be provided in the deck 421 to accommodate the folded upright members. FIG. 26 shows that the deck 421 has platform areas 422 and 423 that are separated by such a recessed area 420 at a midpoint of the deck 421. When in the folded down position, the platforms 422 and 423 extend through the upright members 450 and 460 respectively. Although not shown in FIG. 26, there are also spaces in the deck 421 to accommodate the inner frame 451 and 461 of the upright members. These spaces are molded in the deck in order to keep the surface of the deck consistent when the handles are in the folded down position.

FIG. 30 shows a sixth preferred embodiment of a cart 510 according to the present invention. This sixth embodiment is similar in many respects to the previously described embodiments. In this sixth embodiment, the upright members 550 and 560 have inner frame members 551 and 561. Attached to the inner frame members are cords 500. These cords are wide and can be made from elastic or elastic like material. These cords are used to hold various collapsed cardboard boxes 590.

Accessories can be provided on the cart. For example, as shown in FIG. 31, shelves 991 can be provided to extend between the first and second upright members. These shelves 991 can be used, for example, to separate product or to display product. As shown in FIG. 32, a rod 992 can be provided to extend between the first and second upright members. The rod 992 can be used, for example, as a garment bar to hold clothes. The shelves 991 and rod 992 can be connected to the upright members 50 and 60 by conventional means.

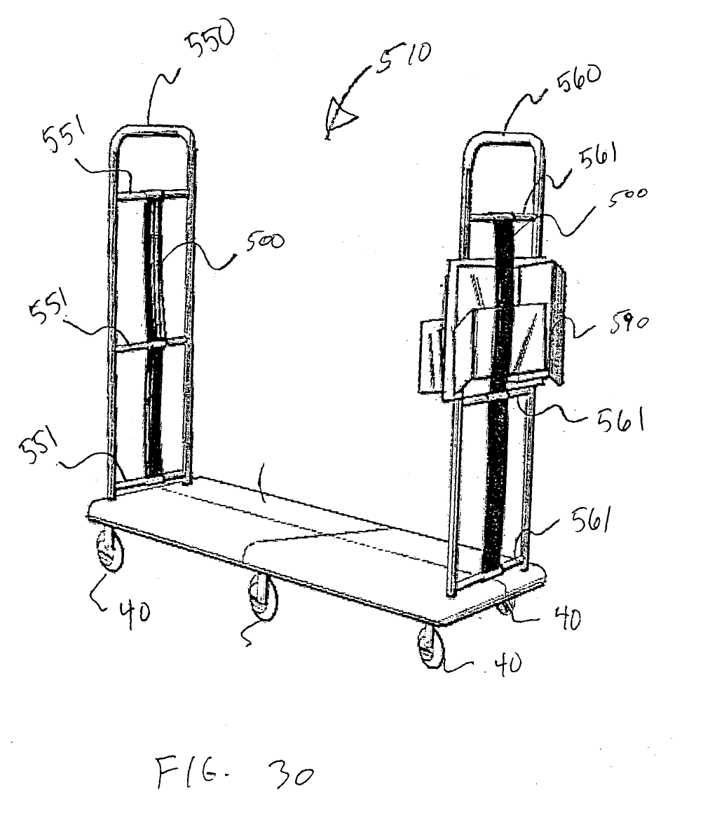

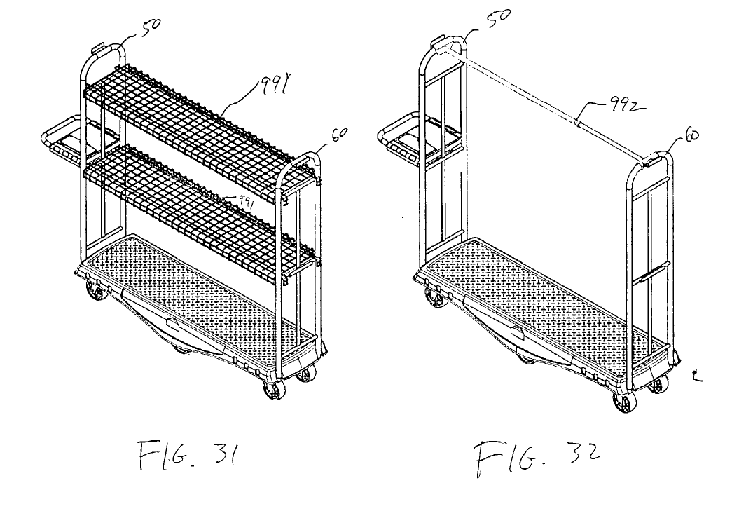

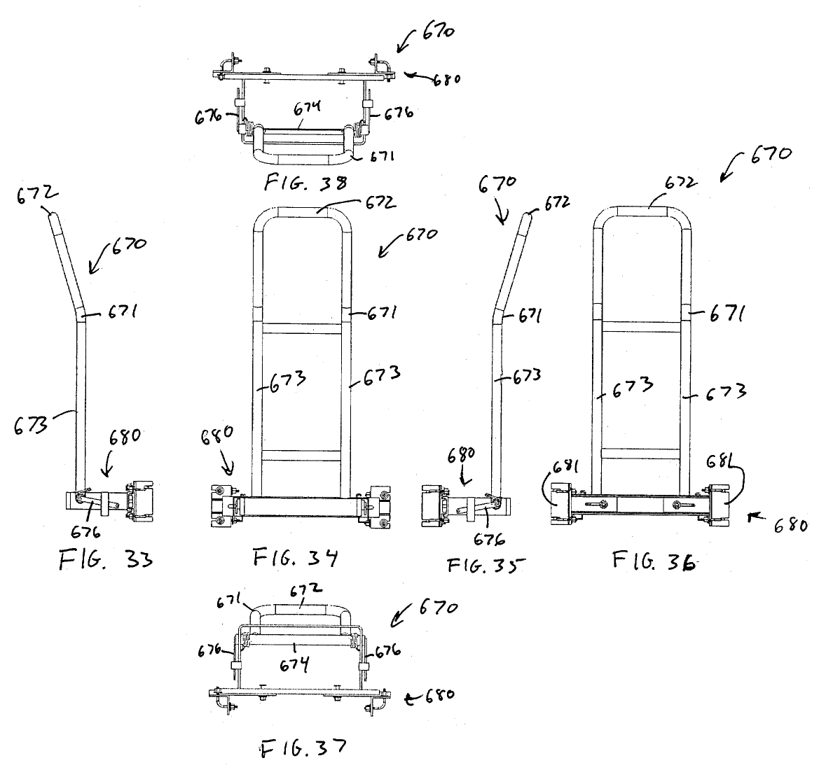

FIGS. 33 to 43 show a seventh preferred embodiment of the present invention. This embodiment includes a holding member 670 for mounting on an upright member 50 extending from a base 20 of a cart 10. The holding member 670 includes a first frame 671 and a mounting mechanism 680. This holding member 670 can be mounted onto carts to retrofit those carts and provide a space for collecting items. Preferably the holding member 670 is adjustable so that it can be mounted on different size carts.

The holding member 670 preferably is made from steel and is formed in part to be an inverted “U”. The holding member 670 can be used as a handle for pulling or pushing the cart. The holding member 670 also can be used to collect, for example, cardboard and other packaging byproducts efficiently.

The first frame 671 is configured to extend upwardly (i.e., substantially vertically) when the holding member 670 is mounted on the upright member 50 to provide an area for holding items between the first frame 671 and the upright member 50. The first frame 671 can have a handle portion 672 and substantially vertical portions 673. The holding member 670 can be configured such that the handle portion 672 is at an appropriate height for gripping by a typical human adult.

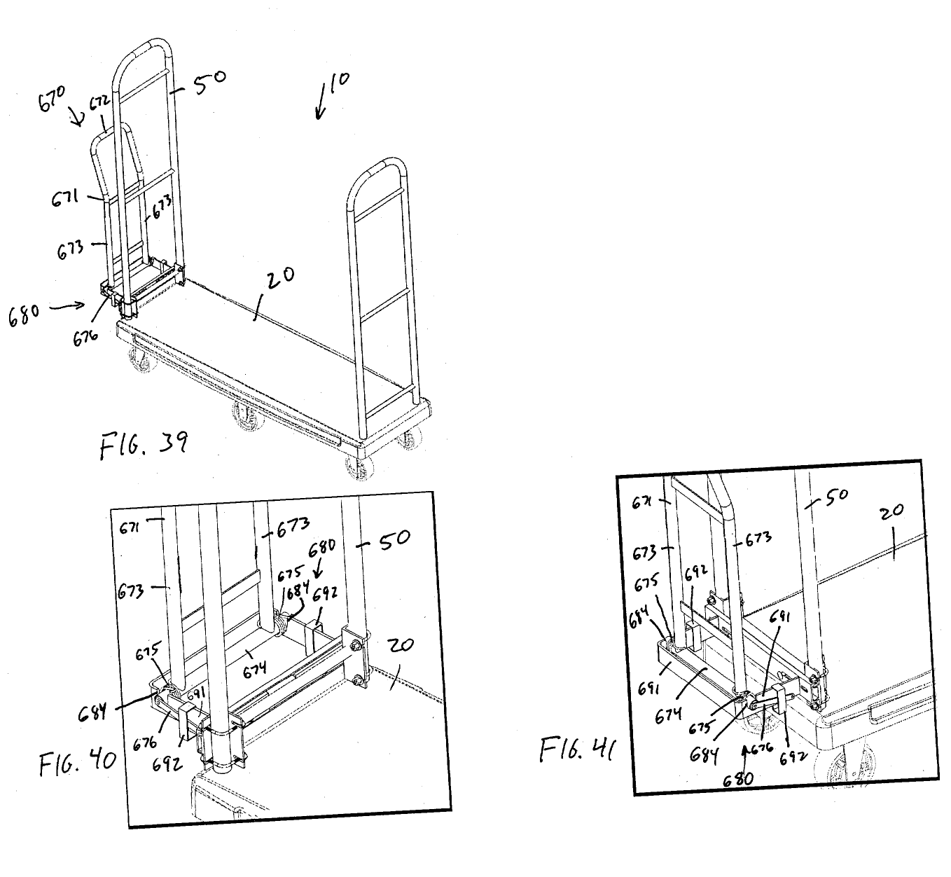

The first frame 671 can be movably connected to the mounting mechanism 680. Preferably, the first frame 671 is pivotally connected to the mounting mechanism 680 such that the first frame 671 can move from a substantially upright position shown in FIG. 33 downward (counterclockwise) in the direction of the arrow. The first frame 671 can preferably rotate about 30° to 40° from the upright position. A lower bar 674 of the first frame 671 rests within receiving portions 684 (see FIGS. 40 and 41) of a horizontal frame 691 of the mounting mechanism 680. The lower bar 674 is received in a manner that permits it to rotate. Biasing members, such as springs 675 (see FIGS. 40 and 41), bias the first frame 671 toward the substantially upright position. The springs 675 also are preferably connected to the lower bar 674 and the horizontal frame 691 to hold the lower bar 674 within the receiving portions 684. Connector bars 676 are connected to the ends of the lower bar 674 and to the horizontal frame 691. When the first frame 671 is rotated downward, the connector bars 676 will move upward until they engage stop mechanisms 692 on the horizontal frame 691. When the connector bars 676 engage the stop mechanisms 692, further rotation of the first frame 671 is prevented.

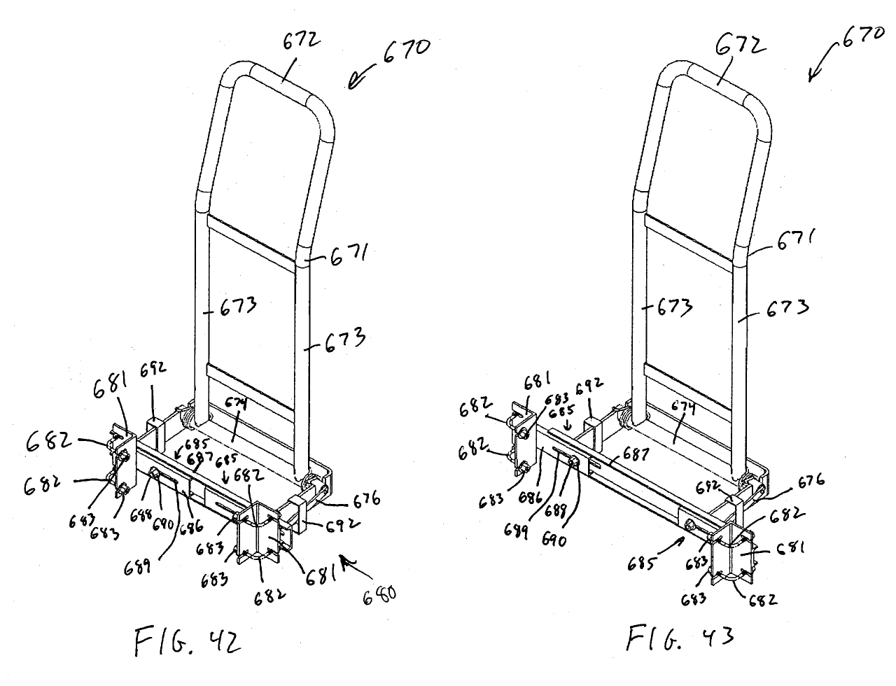

The mounting mechanism 680 mounts the first frame 671 to the upright member 50. The mounting mechanism 680 preferably extends from a bottom portion of the first frame 671. The mounting mechanism 680 preferably includes at least two engaging portions 681 (see FIGS. 36, 42, and 43) configured to engage corresponding portions of the upright member 50. The engaging portions 681 can be fixed members, such as substantially L-shaped structures. Clamping members, such as substantially L shaped bolts 682 and nuts 683 (see FIGS. 42 and 43), can be used to fix the engaging portions 681 to the upright member 50.

As shown in FIGS. 42 and 43, the engaging portions 681 can be adjustably positioned relative to the first frame 671 to permit the holding member 670 to be mounted to different size upright members 50. Though only one of the engaging portions 681 needs to be adjustable, it is preferable that they are both adjustable. Preferably a slidable connector 685 adjustably connects the engaging portion 681 to the first frame 671 to permit the engaging portion 681 to move in a horizontal direction relative to the first frame 671. The slidable connector 685 can include a substantially C-shaped member 686 mounted to the engaging portion 681 that fits into a complementary substantially C-shaped member 687. A bolt 688 extending from the C-shaped member 687 extends into a slot 689 formed in the C-shaped member 686. A nut 690 can be tightened to fix the C-shaped member 686 relative to the C-shaped member 687.

Of course, the present invention can be practiced by combining one or more of the features of one of the embodiments with one or more of the features of the other embodiment.

Other embodiments of the invention will be apparent to those skilled in the art from consideration of the specification and practice of the invention disclosed herein. It is intended that the specification and examples be considered as exemplary only.

What is claimed is:

1. A cart comprising:
a base including
a deck for holding items and having at least a portion configured to move such that the deck can be changed from an expanded-length position to a reduced-length position, and
a frame connected to the deck and configured to be disposed at a first length when the deck is in the expanded-length position and a shorter, second length when the deck is in the reduced-length position;
rolling members supporting the base; and
a first upright member connected to and extending upwardly from the base.

2. The cart of claim 1, wherein the deck includes a first portion that remains fixed relative to the frame and a second portion that can be moved relative to the frame such that the deck can be changed from the expanded-length position to the reduced-length position.

3. The cart of claim 2, wherein the second portion is connected to the first portion by a hinge that allows the second portion to pivot relative to the first portion.

4. The cart of claim 2, further comprising an arm extending between the second portion and the frame, the arm causing the second portion to move toward the reduced-length position as the frame is moved toward the second length.

5. The cart of claim 1, wherein the rolling members include first and second wheels positioned at a first end portion of the base, third and fourth wheels positioned at a mid-portion of the base, and fifth and sixth wheels positioned at a second end portion of the base, wherein the third and fourth wheels have larger diameters than the first, second, fifth, and sixth wheels.

6. The cart of claim 1, wherein the first upright member is configured to fold toward the base.

7. The cart of claim 1, further comprising a second upright member connected to and extending upwardly from the base, wherein the first upright member is disposed at a first end portion of the base and the second upright member is disposed at a second end portion of the base.

8. The cart of claim 7, further comprising at least one handle portion on the first upright member and at least one handle portion on the second upright member.

9. The cart of claim 7, further comprising a rod extending between the first and second upright members.

10. The cart of claim 7, further comprising a shelf extending between the first and second upright members.

11. A cart comprising:
a base for holding items;
rolling members supporting the base;
a first upright member connected to and extending upwardly from the base; and
a holding member that is moveable relative to the first upright member and configured to hold refuse from the items, wherein the holding member is connected to at least one of the base and the first upright member.

12. The cart of claim 11, wherein the rolling members include first and second wheels positioned at a first end portion of the base, third and fourth wheels positioned at a mid portion of the base, and fifth and sixth wheels positioned at a second end portion of the base, wherein the third and fourth wheels have larger diameters than the first, second, fifth, and sixth wheels.

13. The cart of claim 11, wherein the first upright member is configured to fold toward the base.

14. The cart of claim 11, wherein the holding member includes a first frame slidably mounted to at least one of the first upright member and the base.

15. The cart of claim 14, wherein the holding member includes an engaging member that limits movement of the first frame relative to the first upright member.

16. The cart of claim 11, wherein the holding member includes a first frame pivotally mounted to at least one of the first upright member and the base.

17. The cart of claim 16, wherein the holding member includes biasing device that biases the first frame to pivot toward the first upright member.

18. The cart of claim 16, wherein the holding member includes a second frame pivotally mounted to at least one of the first upright member and the base.

19. The cart of claim 16, wherein the holding member includes an engaging member that maintains the first frame in a fixed position relative to the first upright member.

20. The cart of claim 11, wherein the holding member includes at least one elongated elastic member mounted to the first upright member.

21. The cart of claim 11, further comprising a second upright member connected to and extending upwardly from the base, wherein the first upright member is disposed at a first end portion of the base and the second upright member is disposed at a second end portion of the base.

22. The cart of claim 21, further comprising at least one handle portion on the first upright member and at least one handle portion on the second upright member.

23. The cart of claim 2 1, further comprising a rod extending between the first and second upright members.

24. The cart of claim 21, further comprising a shelf extending between the first and second upright members.

25. A cart comprising:
a base for holding items;
rolling members supporting the base;
a first upright member connected to and extending upwardly from the base; and
a placard attached to the first upright member and having a surface for displaying information, wherein the surface is configured such that the information can be changed.

26. The cart of claim 25, wherein the rolling members include first and second wheels positioned at a first end portion of the base, third and fourth wheels positioned at a mid portion of the base, and fifth and sixth wheels positioned at a second end portion of the base, wherein the third and fourth wheels have larger diameters than the first, second, fifth, and sixth wheels.

27. The cart of claim 25, wherein the surface includes an erasable writing surface.

28. The cart of claim 25, wherein the placard includes a holder for holding a writing instrument.

29. The cart of claim 25, wherein the placard is connected to a top end portion of the first upright member.

30. The cart of claim 25, further comprising a second upright member connected to and extending upwardly from the base, wherein the first upright member is disposed at a first end portion of the base and the second upright member is disposed at a second end portion of the base.

31. The cart of claim 30, further comprising at least one handle portion on the first upright member and at least one handle portion on the second upright member.

32. The cart of claim 30, further comprising a rod extending between the first and second upright members.

33. The cart of claim 30, further comprising a shelf extending between the first and second upright members.

34. A holding member for mounting on an upright member extending from a base of a cart, the holding member comprising:
a first frame configured to extend upwardly when the holding member is mounted on the upright member to provide an area for holding items between the first frame and the upright member; and
a mounting mechanism for mounting the first frame to the upright member, the mounting mechanism including at least two engaging portions configured to engage corresponding portions of the upright member, wherein at least one of the engaging portions is adjustably connected to the first frame to permit the holding member to be mounted to different size upright members.

35. The holding member of claim 34, wherein the mounting mechanism extends from a bottom portion of the first frame.

36. The holding member of claim 34, wherein the mounting mechanism includes a slidable connector that adjustably positions the at least one engaging portion relative to the first frame to permit the at least one engaging portion to move in a horizontal direction relative to the first frame.

37. The holding member of claim 34, wherein the first frame is movably connected to the mounting mechanism.

38. The holding member of claim 37, wherein the first frame is pivotally connected to the mounting mechanism.

39. The holding member of claim 38, wherein a biasing member biases the first frame toward a substantially upright position.

40. A method for moving stock, comprising the steps of:
providing a mobile cart having an upright member and a placard disposed on the upright member;
identifying an item to be stocked;
placing the item on the mobile cart;
indicating on the placard a desired stocking location for the item;
moving the mobile cart to the desired stocking location; and
removing the item from the mobile cart and placing the item in the desired stocking location.
